(19) United States
(12) Patent Application Publication
(10) Pub. No.: US 2025/0245786 A1
(43) Pub. Date: Jul. 31, 2025

(54) METHOD AND ELECTRONIC DEVICE FOR ANALYZING MAKEUP BY USING MULTISPECTRAL IMAGE SENSOR

(71) Applicant: SAMSUNG ELECTRONCIS CO., LTD., Suwon-si (KR)

(72) Inventors: Suyeon LEE, Suwon-si (KR); Unjeong Kim, Suwon-si (KR); Hojung Kim, Suwon-si (KR)

(73) Assignee: SAMSUNG ELECTRONCIS CO., LTD., Suwon-si (KR)

(21) Appl. No.: 18/807,636

(22) Filed: Aug. 16, 2024

(30) Foreign Application Priority Data
Jan. 25, 2024 (KR) 10-2024-0011720

(51) Int. Cl. G06T 5/50; G06T 7/00

(52) U.S. Cl. CPC G06T 5/50; G06T 7/00; G06T 2207/10036

(57) ABSTRACT

Provided is a method of analyzing makeup by a multispectral image sensor, the method including measuring a reflection spectrum of skin by the multispectral image sensor, normalizing the measured reflection spectrum by matching a value of the measured reflection spectrum and a value of a pre-acquired reflection spectrum at two wavelengths, and analyzing makeup of the skin based on a comparing the normalized reflection spectrum and the pre-acquired reflection spectrum at a specific wavelength.

### CROSS-REFERENCE TO RELATED APPLICATION

This application claims priority to Korean Patent Application No. 10-2024-0011720, filed on Jan. 25, 2024, in the Korean Intellectual Property Office, the disclosure of which is incorporated by reference herein in its entirety.

### BACKGROUND

### 1. Field

Example embodiments of the present disclosure relate to a method of analyzing makeup by using a multispectral image sensor (MIS).

### 2. Description of Related Art

As interest in skin care increases, not only women but also men and adolescents are increasingly wearing makeup.

For natural skin representation, correct makeup is needed. Makeup may be lightly applied to areas where skin is thin, such as around the mouth and eyes. In order to prevent staining with makeup, the makeup may be uniformly applied as a whole. In addition, when makeup is modified over time, the modified makeup may be corrected.

### SUMMARY

One or more example embodiments provide a method of analyzing a user's makeup and providing a makeup guide for correct makeup.

One or more example embodiments also provide a method and an electronic device for analyzing makeup using a multispectral image sensor.

Additional aspects will be set forth in part in the description which follows and, in part, will be apparent from the description, or may be learned by practice of example embodiments of the disclosure.

According to an aspect of an example embodiment, there is provided a method of analyzing makeup by a multispectral image sensor, the method including measuring a reflection spectrum of skin by the multispectral image sensor, normalizing the measured reflection spectrum by matching a value of the measured reflection spectrum and a value of a pre-acquired reflection spectrum at two wavelengths, and analyzing makeup of the skin based on a comparing the normalized reflection spectrum and the pre-acquired reflection spectrum at a specific wavelength.

The measuring of the reflection spectrum of the skin may include measuring the reflection spectrum of the skin by the multispectral image sensor that includes channels respectively corresponding to the two wavelengths and the specific wavelength.

The specific wavelength may be included in a range of 570 nm to 600 nm.

The specific wavelength may be between the two wavelengths.

The normalizing of the measured reflection spectrum may further include shifting the measured reflection spectrum to match the measured reflection spectrum and the pre-acquired reflection spectrum at one of the two wavelengths, and scaling the shifted reflection spectrum to match the measured reflection spectrum and the pre-acquired reflection spectrum at the other of the two wavelengths.

The analyzing of the makeup of the skin may further include analyzing a condition of the makeup of the skin based on a difference between the normalized reflection spectrum and the pre-acquired reflection spectrum at the specific wavelength.

The analyzing of the makeup of the skin may further include analyzing a condition of the makeup of the skin based on a difference in a slope of the normalized reflection spectrum and a slope the pre-acquired reflection spectrum at the specific wavelength.

The analyzing of the makeup of the skin may further include analyzing a condition of the makeup of the skin, and providing a makeup guide to a user.

The measuring of the reflection spectrum of the skin may include emitting electromagnetic waves by a light source through a first polarizing plate to the skin, and measuring, by the multispectral image sensor, the electromagnetic waves that have been reflected by the skin and have passed through a second polarizing plate that has a polarizing axis perpendicular to a polarizing axis of the first polarizing plate.

The pre-acquired reflection spectrum may be a reflection spectrum of the skin without makeup.

According to another aspect of an example embodiment, there is provided an electronic device for analyzing makeup, the electronic device including a multispectral image sensor configured to measure a reflection spectrum of skin, a memory configured to store one or more instructions, and at least one processor configured to execute the one or more instructions stored in the memory, wherein the at least one processor is, by executing the one or more instructions, configured to normalize the measured reflection spectrum to match a value of the measured reflection spectrum and a value of a pre-acquired reflection spectrum at two wavelengths, and analyze the makeup of the skin based on comparing the normalized reflection spectrum and the pre-acquired reflection spectrum at a specific wavelength.

The multispectral image sensor may include channels corresponding to the two wavelengths and the specific wavelength.

The specific wavelength may be included in a range of 570 nm to 600 nm.

The specific wavelength may be between the two wavelengths.

The at least one processor may be, by executing the one or more instructions, configured to shift the measured reflection spectrum to match the measured reflection spectrum and the pre-acquired reflection spectrum at one of the two wavelengths, and scale the shifted reflection spectrum to match the measured reflection spectrum and the pre-acquired reflection spectrum at the other of the two wavelengths.

The at least one processor may be, by executing the one or more instructions, further configured to analyze a condition of the makeup of the skin based on a difference between a value of the normalized reflection spectrum and a value of the pre-acquired reflection spectrum at the specific wavelength.

The at least one processor may be, by executing the one or more instructions, further configured to analyze a condition of the makeup of the skin based on a difference in a value of a slope of the normalized reflection spectrum and a value of a slope of the pre-acquired reflection spectrum at the specific wavelength.

The at least one processor may be, by executing the one or more instructions, further configured to analyze a condition of the makeup of the skin, and provide a makeup guide to a user.

The electronic device may further include a light source, a first polarizing plate configured to transmit electromagnetic waves emitted from the light source, and a second polarizing plate configured to transmit the electromagnetic waves reflected from a skin, wherein the multispectral image sensor is further configured to measure the electromagnetic waves transmitted through the second polarizing plate, and wherein a polarizing axis of the first polarizing plate is perpendicular to a polarizing axis of the second polarizing plate.

According to still another aspect of an example embodiment, there is provided a non-transitory computer-readable recording medium having recorded thereon a program for executing a method on a computer, the method including measuring a reflection spectrum of skin by a multispectral image sensor, normalizing the measured reflection spectrum by matching a value of the measured reflection spectrum and a value of a pre-acquired reflection spectrum at two wavelengths, and analyzing makeup of the skin based on a comparing the normalized reflection spectrum and the pre-acquired reflection spectrum at a specific wavelength.

According to further still another aspect of an example embodiment, there is provided an electronic device for analyzing makeup, the electronic device including a light source configure to emit electromagnetic waves to skin, a multispectral image sensor configured to measure a reflection spectrum of the skin based on the electromagnetic waves reflected from the skin, and at least one processor configured to normalize the measured reflection spectrum to match a value of the measured reflection spectrum and a value of a pre-acquired reflection spectrum at two wavelengths, and analyze makeup of the skin based on comparing the normalized reflection spectrum and the pre-acquired reflection spectrum at a specific wavelength, wherein the multispectral image sensor includes channels corresponding to the two wavelengths and the specific wavelength.

### BRIEF DESCRIPTION OF DRAWINGS

The above and other aspects, features, and advantages of example embodiments of the disclosure will be more apparent from the following description taken in conjunction with the accompanying drawings, in which:

FIG. 1 is a diagram illustrating functions of an electronic device according to an example embodiment;

FIGS. 2A and 2B are block diagrams of an electronic device according to example embodiments;

FIG. 3 is a graph of reflection spectra of makeup according to an example embodiment;

FIG. 4 illustrates changes in a makeup condition on skin over time, according to an example embodiment;

FIG. 5 is a graph illustrating a wavelength spectrum of a multispectral image sensor according to an example embodiment;

FIG. 6 illustrates changes in a makeup condition on skin over time, according to an example embodiment;

FIG. 7 illustrates skin photographed in different manners, according to an example embodiment;

FIG. 8 shows graphs for explaining analysis of reflection spectra of skin, according to an example embodiment;

FIG. 9 shows graphs for explaining changes in reflection spectra of skin, according to an example embodiment;

FIG. 10 illustrates graphs for describing normalization of reflection spectra, according to an example embodiment;

FIG. 11 is a diagram for describing a method of measuring a reflection spectrum by using polarizing plates, according to an example embodiment; and

FIGS. 12 and 13 are flowcharts illustrating a method of analyzing makeup by using a multispectral image sensor according to example embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list. For example, an expression, “at least one of a, b, and c” should be understood as including only a, only b, only c, both a and b, both a and c, both b and c, or all of a, b, and c. In the present disclosure, the articles “a” and “an” are intended to include one or more items, and may be used interchangeably with “one or more.” Where only one item is intended, the term “one” or similar language is used. For example, the term “a processor” may refer to either a single processor or multiple processors. When a processor is described as carrying out an operation and the processor is referred to perform an additional operation, the multiple operations may be executed by either a single processor or any one or a combination of multiple processors.

Hereinafter, various example embodiments of the disclosure are described with reference to the accompanying drawings.

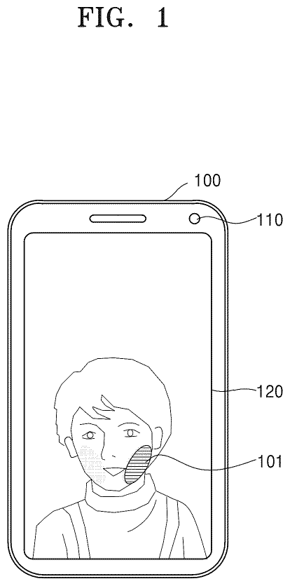

FIG. 1 is a diagram illustrating functions of an electronic device 100 according to an example embodiment.

The electronic device 100 according to an example embodiment may include a camera 110 and a display panel 120. For example, the electronic device 100 may be a smartphone, a tablet, or a notebook computer, but is not limited thereto.

The electronic device 100 may analyze a user's makeup. The electronic device 100 may measure a reflection spectrum from the user's skin through the camera 110. The electronic device 100 may analyze a user's makeup condition based on the measured reflection spectrum. The electronic device 100 may display, on the display panel 120, an analysis result of the makeup condition and a makeup guide.

An image of a user captured by the camera 110 may be displayed on the display panel 120. The electronic device 100 may analyze makeup on the entire area of the user's skin displayed on the display panel 120. According to another example embodiment, the electronic device 100 may analyze makeup for a region of interest (ROI) of the user's skin.

In an example embodiment, the region of interest may be automatically set. The electronic device 100 may recognize a region of interest in an image based on various image processing algorithms. For example, the region of interest may be automatically set as the user's face region, eye region, cheek region, jaw region, or forehead region.

In an example embodiment, the area of interest may be automatically set according to the type of makeup the user wants to use for makeup. For example, when the type of makeup is a foundation, the region of interest may be automatically set as the user's face region, and when the type of makeup is an eyeshadow, the region of interest may be automatically set as the user's eye region.

In an example embodiment, the region of interest may be manually set by the user. The user may select the region of interest 101 of the user's skin on the image displayed on the display panel 120.

The electronic device 100 may provide a makeup guide to the user based on the analysis result of the makeup condition of the user's skin.

In an example embodiment, the electronic device 100 may provide a user with a corrected makeup guide for a skin region. For example, the electronic device 100 may provide a makeup guide to the user so that the user applies a relatively thin layer of foundation to regions in which the user's skin is relatively thin, such as the peripheral regions of the user's eyes, and applies a relatively thick layer of foundation to regions in which the user's skin is relatively thick, such as the user's cheeks.

In an example embodiment, the electronic device 100 may provide the user with the corrected makeup guide such that the makeup is uniformly applied. For example, the electronic device 100 may provide a makeup guide to the user such that the makeup on the left side and the right side of the user's face are symmetrical.

In an example embodiment, the electronic device 100 may guide the user whether the makeup needs to be corrected. For example, when the electronic device 100 determines that the user's makeup needs to be corrected because the makeup is incorrectly applied or the makeup has been modified over time, the electronic device 100 may inform the user that the makeup needs to be corrected.

In an example embodiment, the electronic device 100 may guide the user to a region where the makeup needs to be corrected. For example, the electronic device 100 may guide the user to regions that require correction of makeup, such as, for example, regions where makeup has been removed, regions where makeup has been stained, or regions where makeup is uneven.

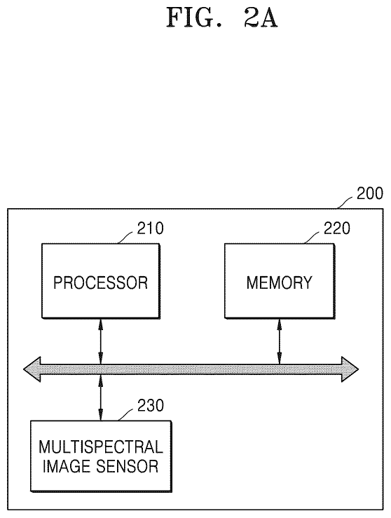

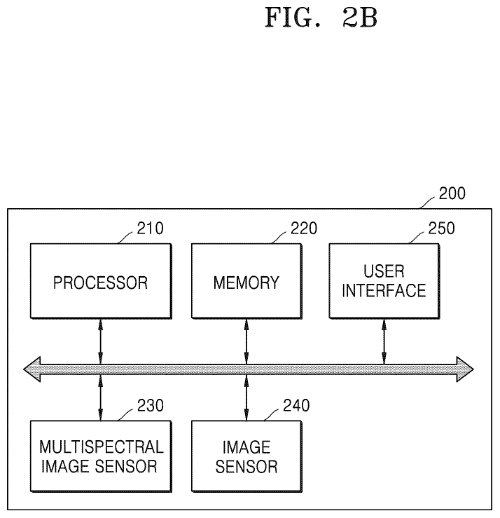

FIG. 2A is a block diagram of an electronic device 200 according to an example embodiment.

The electronic device 200 according to an example embodiment may include a processor 210, a memory 220, and a multispectral image sensor 230.

The memory 220 may be configured to store one or more instructions. For example, the memory 220 may be, but is not limited to, on-chip memory, cache memory, random access memory (RAM), read only memory (ROM), flash memory, solid state drive (SSD), hard disk drive (HDD), or optical disk drive (ODD).

The processor 210 may be configured to analyze the reflection spectrum from the skin by executing one or more instructions stored in the memory 220. For example, the processor 210 may be, but is not limited to, a central processing unit (CPU), an application processor (AP), a digital signal processor (DSP), a graphics processing unit (GPU), a vision processing unit (VPU), or a neural processing unit (NPU).

The multispectral image sensor 230 may be configured to measure the reflection spectrum from the skin. The multispectral image sensor 230 may include a multispectral filter array (MSFA) that transmits light for each band in each channel. The MSFA may have a one-dimensional or two-dimensional array. For example, when the number of channels is 36, the MSFA may be a 6×6 array. However, embodiments are not limited thereto.

The filter of each channel may transmit light in a specific band. The filter may have a resonance structure. The transmission band of the filter may be determined according to a resonance structure. For example, the transmission band may be adjusted according to the material included in a reflective layer, the material included in a cavity, and the thickness of the cavity. The filter may be implemented by a grating, a nanostructure, a distributed Bragg reflector (DBR), or other methods.

In an example embodiment, the multispectral image sensor 230 may include, for example, a complementary metal oxide semiconductor (CMOS) image sensor, a charge coupled device (CCD) image sensor, or a single photon avalanche diode (SPAD) image sensor.

FIG. 2B is a block diagram of an electronic device 200 according to example embodiment.

In describing FIG. 2B, redundant descriptions with those described with reference to FIG. 2A are omitted for brevity.

The electronic device 200 according to an example embodiment may include a processor 210, a memory 220, a multispectral image sensor 230, a red-green-blue (RGB) image sensor 240, and a user interface 250.

The RGB image sensor 240 has a red (R) channel, a green (G) channel, and a blue (B) channel. The image acquired by the RGB image sensor 240 may be an RGB image based on red, green, and blue.

The multispectral image sensor 230 may include a plurality of channels having different center wavelengths of the measurement bands. The multispectral image sensor 230 may have a greater number of channels than the RGB image sensor 240. The entire bands of the multispectral image sensor 230 may include a visible light band. For example, the multispectral image sensor 230 may generate images of 64 channels within a wavelength range of about 10 nm to about 1000 nm.

The multispectral image sensor 230 may measure the reflection spectrum from the skin. Since the multispectral image sensor 230 has a greater number of channels than the RGB image sensor 240, the reflection spectrum from the skin may be measured with high resolution.

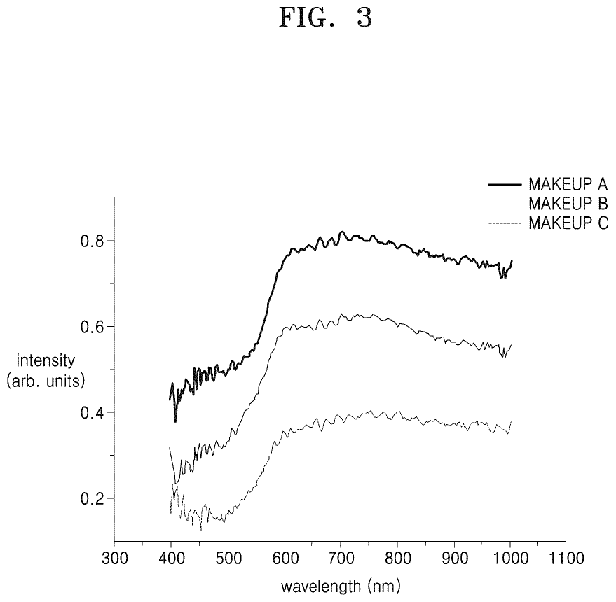

Makeup may have different reflection spectra depending on ingredients. By measuring the reflection spectrum with high resolution by the multispectral image sensor 230, makeup having different ingredients may be identified. For example, in FIG. 3, reflection spectra of different makeups including makeup A, makeup B, and makeup C including different ingredients measured by the multispectral image sensor 230 are shown. FIG. 3 illustrates that reflection spectrum of each makeup having different ingredients may have different intensities and be different from each other.

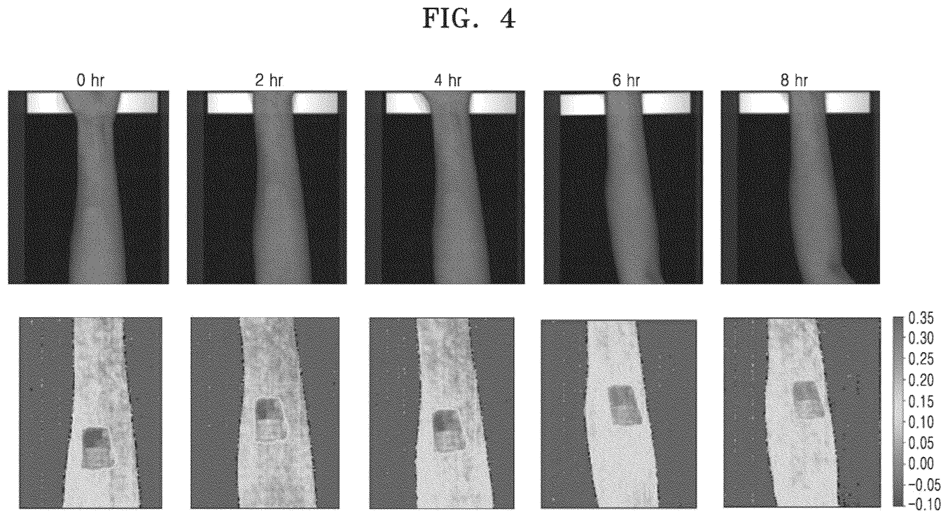

Makeup may change over time. By measuring the reflection spectrum with a relatively high resolution by the multispectral image sensor 230, information on a change in makeup applied to the skin may be obtained. For example, the first row of FIG. 4 shows images of the makeup-applied skin over time such as time passed from initially applying makeup, and the second row of FIG. 4 shows analysis results of the reflection spectrum from the makeup-applied skin and measured by the multispectral image sensor 230. From the analysis results, it may be seen that a change in makeup applied to the skin may be analyzed based on the reflection spectra measured by the multispectral image sensor 230.

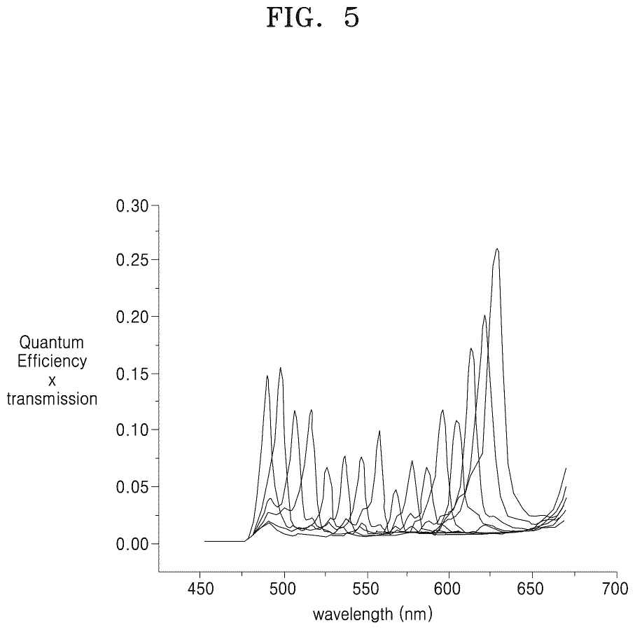

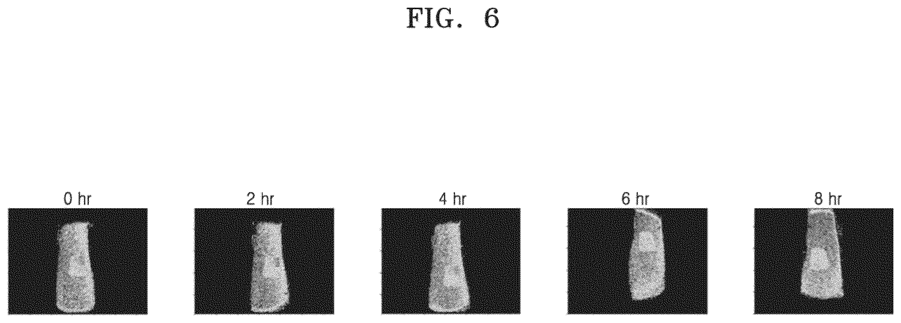

As the number of channels of the multispectral image sensor 230 increases, the resolution of the multispectral image sensor may increase. In an example embodiment, the multispectral image sensor 230 may have a number of channels for analyzing skin makeup. For example, the multispectral image sensor 230 may include 16 channels with graphs of wavelength spectra shown in FIG. 5 in which quantum efficiency multiplied by transmission with respect to the wavelengths of light is provided. For example, 16 channels may be a number of channels capable to identify the result of deformation of makeup applied to the skin over time passed from initially applying makeup, as shown in FIG. 6.

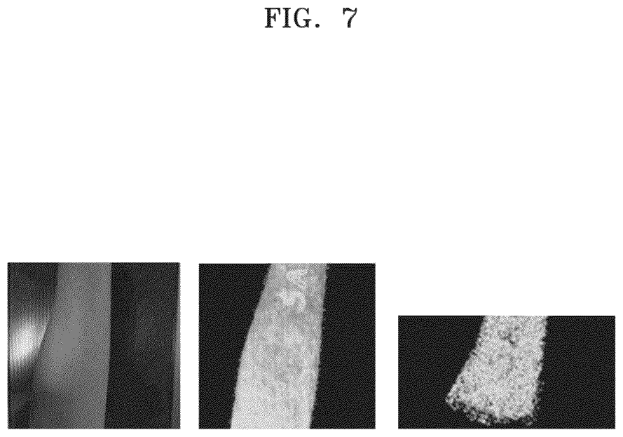

The multispectral image sensor 230 may measure the reflection spectrum from the skin by a line scan method or a snap shot method. For example, FIG. 7 shows an image of the skin with makeup (left image), an analysis result of the reflection spectrum from the makeup-applied skin measured by the line scan method (center image), and an analysis result of the reflection spectrum from the makeup-applied skin measured by the snap shot method (right image). The letter written by makeup may be identified from both the center image and the right image, which indicates that a line scan method and a snap shot method may be used to measure the reflection spectrum from the skin to analyze makeup.

The processor 210 may analyze the makeup of the skin based on the reflection spectrum from the user's skin measured through the multispectral image sensor 230. For example, the processor 210 may analyze whether or not makeup is applied to the skin, the concentration of makeup applied to the skin, and the type of makeup applied to the skin using image processing algorithms.

The processor 210 may analyze the makeup of the skin based on a comparison between the measured reflection spectrum and a pre-acquired reflection spectrum. The pre-acquired reflection spectrum may be a reflection spectrum obtained from the skin of a user without makeup. The processor 210 may analyze the makeup of the skin based on a difference in values or slopes of the measured reflection spectrum and the pre-acquired reflection spectrum.

The processor 210 may normalize the measured reflection spectrum and compare the normalized reflection spectrum with the pre-acquired reflection spectrum.

In an example embodiment, to normalize the measured reflection spectrum, the multispectral image sensor 230 may measure a reflection spectrum from an object having known reflection characteristics, or measure a spectrum of illumination. The processor 210 may normalize the reflection spectrum from the skin based on the reflection spectrum from an object having known reflection characteristics or the spectrum of illumination.

In an example embodiment, the processor 210 may normalize the measured reflection spectrum such that values of the measured reflection spectrum and the pre-acquired reflection spectrum coincide at two wavelengths. The processor 210 may analyze the makeup of the skin based on a comparison between the normalized reflection spectrum and the pre-acquired reflection spectrum at a specific wavelength. The processor 210 may analyze the makeup of the skin based on a difference in values or slopes of the normalized reflection spectrum and the pre-acquired reflection spectrum at a specific wavelength.

Two wavelengths used for normalization of the measured reflection spectrum may be predetermined. In addition, a specific wavelength used for comparison of a measured reflection spectrum with a pre-acquired reflection spectrum may be predetermined.

The multispectral image sensor 230 may include respective channels corresponding to two wavelengths and a specific wavelength. For example, the multispectral image sensor 230 may have two wavelengths as respective measurement bands for two channels, and a specific wavelength as a measurement band for another channel. The relatively large number of channels and high resolution of the multispectral image sensor 230 may enable the multispectral image sensor 230 to obtain a reflection spectrum with high accuracy at two wavelengths and at a specific wavelength.

The user interface 250 may include an input device for receiving a user's input and an output device for providing information to the user. For example, the input device may include, but is not limited to, a touch panel, a touch pad, a keypad, a pen recognition panel, or a microphone. For example, the output device may include, but is not limited to, a display panel or a speaker, but is not limited thereto.

The processor 210 may display an image of a user acquired through the multispectral image sensor 230 or the RGB image sensor 240 on the display panel (120 of FIG. 1). The user may designate a region of interest in the displayed image using the input device. For example, the user may designate a region of interest in the displayed image using a touch panel or microphone. The processor 210 may analyze the makeup of the skin based on the reflection spectrum from the skin included in the region of interest.

The processor 210 may provide a makeup guide to the user through the output device based on the makeup condition of the skin. For example, the processor 210 may provide a makeup guide to a user through a display panel or a speaker. For example, the processor 210 may provide the user with a makeup guide, such as whether the makeup should be corrected, where the skin region to be corrected is, what kind of makeup should be corrected with, or to what extent the makeup should be corrected.

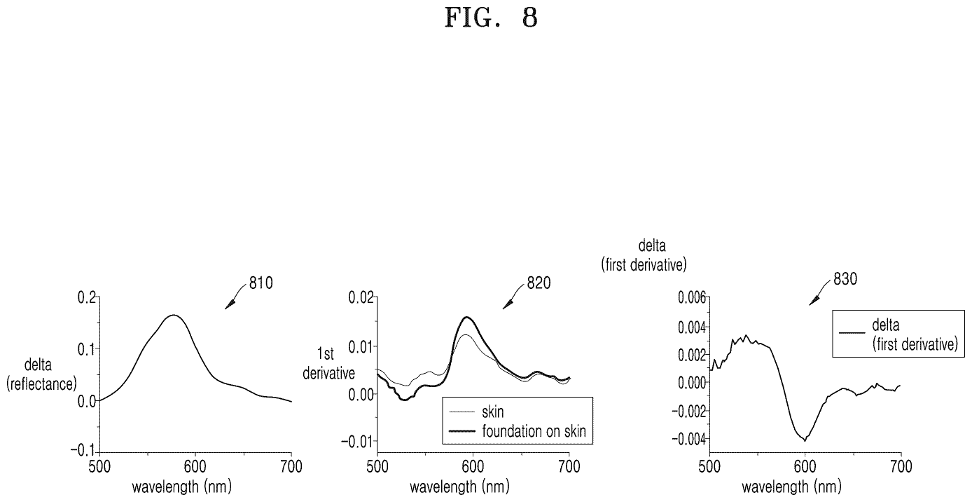

FIG. 8 shows graphs for explaining analysis of a reflection spectrum of skin according to an example embodiment.

The reflectance of the skin decreases in the wavelength band of about 570 nm to about 600 nm because the absorption spectra of hemoglobin and oxidized hemoglobin increase in the wavelength band of about 570 nm to about 600 nm. In the wavelength range of about 570 nm to about 600 nm, the influence of the increased absorption spectrum of hemoglobin and oxidized hemoglobin is reduced on the reflection spectrum from the makeup-applied skin, and the influence of the increased absorption spectrum of hemoglobin and oxidized hemoglobin is reflected in the reflection spectrum from the skin having no makeup. Accordingly, the difference between the reflection spectra from the skin with makeup and the skin without makeup increases.

For the same reason, as the reflectance of the skin decreases in the wavelength band of about 570 nm to about 600 nm, the amount of change in the reflectance of the skin increases. Accordingly, in the wavelength band of about 570 nm to about 600 nm, the difference in slopes of the reflection spectrum of the makeup skin and the reflection spectrum of the non-makeup skin increases.

A first graph 810 shows a difference between a reflection spectrum of makeup skin and a reflection spectrum of non-makeup skin according to an example embodiment. A second graph 820 shows a first derivative of the reflection spectrum of the makeup skin and a first derivative of the reflection spectrum of the non-makeup skin, according to an example embodiment. A third graph 830 shows a difference between a first derivative of the reflection spectrum of the makeup skin and a first derivative of the reflection spectrum of the non-makeup skin, according to an example embodiment.

From the first graph 810, it may be confirmed that the difference between the reflection spectrum of the makeup skin and the reflection spectrum of the non-makeup skin in the wavelength band of about 570 nm to about 600 nm has the largest value. In addition, from the third graph 830, it may be confirmed that the difference (absolute value) in the slopes of the reflection spectrum of skin with makeup and the reflection spectrum of skin without makeup has the largest value in the wavelength band of about 570 nm to about 600 nm.

The electronic device may increase the performance of the analysis by analyzing the reflection spectrum from the skin at a specific wavelength in which the difference between the reflection spectrum of the makeup skin and the reflection spectrum of the non-makeup skin is most clearly visible.

In an example embodiment, the specific wavelength may be included in a wavelength band of about 570 nm to about 600 nm. For example, the electronic device may analyze a difference between the reflection spectrum of the makeup skin and the reflection spectrum of the non-makeup skin at a specific wavelength of about 578 nm. For example, the electronic device may analyze a difference in slopes of the reflection spectrum of the makeup skin and the reflection spectrum of the non-makeup skin at a specific wavelength of about 600 nm.

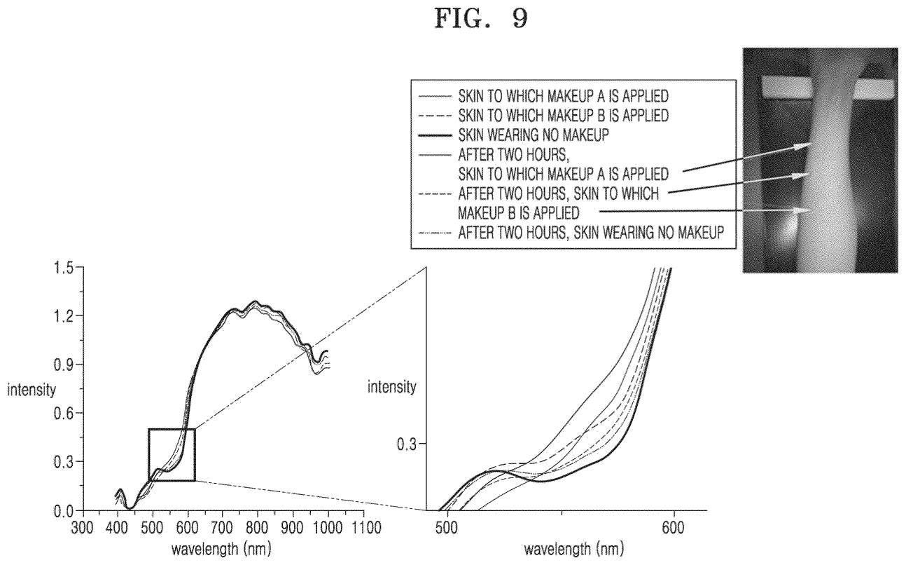

FIG. 9 shows graphs for explaining a change in a reflection spectrum of skin according to an example embodiment.

FIG. 9 shows the reflection spectrum of the skin to which makeup A is applied, the reflection spectrum from the skin to which makeup B is applied, the reflection spectrum from the skin to which no makeup is applied, the reflection spectrum after 2 hours from the skin to which makeup A is applied, the reflection spectrum after 2 hours from the skin to which makeup B is applied, and the reflection spectrum after 2 hours from the skin on which no makeup is applied, which are all measured by the multispectral image sensor.

FIG. 9 shows that the reflection spectra of the skin change depending upon the presence or absence of makeup, the type of makeup, and the passage of time. Accordingly, the electronic device may identify and analyze the makeup condition of the skin, such as the presence or absence of makeup, the type of makeup, and the elapsed time after makeup, from the reflection spectrum measured by the multispectral image sensor.

The value of the reflection spectrum of the skin may vary depending on the race or skin tone of the user. For example, the value of the reflection spectrum of the skin of the Caucasian may be greater than the value of the reflection spectrum of the skin of the Mongoloid. Accordingly, the electronic device may analyze the makeup condition of the skin in consideration of the user's race or skin tone.

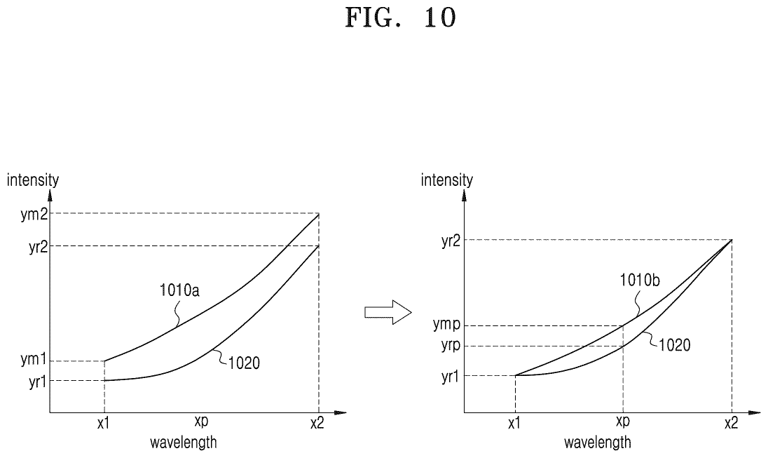

FIG. 10 illustrates graphs for describing normalization of a reflection spectrum according to an example embodiment.

The electronic device may measure the reflection spectrum from the skin through the multispectral image sensor and analyze the makeup of the skin based on a comparison between the measured reflection spectrum and a pre-acquired reflection spectrum. In an example embodiment, the measured reflection spectrum may be a reflection spectrum from the user's skin with makeup applied (makeup skin), and the pre-acquired reflection spectrum may be a reflection spectrum from the user's skin without makeup applied (non-makeup skin).

The measured reflection spectrum and the pre-acquired reflection spectrum may be measured in different environments. For example, the reflection spectrum (i.e., the measured reflection spectrum) of the makeup skin may be obtained under relatively bright lighting that may be brighter than natural light, and the reflection spectrum (i.e., the pre-acquired reflection spectrum) of the non-makeup skin may be obtained under natural light. The electronic device may normalize the measured reflection spectrum so that the measured reflection spectrum and the pre-acquired reflection spectrum may be compared and analyzed under the same reference.

The left graph of FIG. 10 shows the measured reflection spectrum 1010a and the pre-acquired reflection spectrum 1020 according to an example embodiment, and the right graph of FIG. 10 shows the normalized reflection spectrum 1010b and the pre-acquired reflection spectrum 1020 according to an example embodiment.

The electronic device may determine in advance the first wavelength x1 and the second wavelength x2 for normalization and a specific wavelength xp for analysis of the reflection spectrum. The electronic device may determine the specific wavelength xp such that the specific wavelength xp is included in a range of about 570 nm to about 600 nm. The electronic device may determine the first and second wavelengths x1 and x2 such that a specific wavelength xp is positioned between the first and second wavelengths x1 and x2. For example, the specific wavelength xp may be about 600 nm, the first wavelength x1 may be about 500 nm, and the second wavelength x2 may be about 700 nm.

The electronic device may shift the measured reflection spectrum 1010a so that values of the measured reflection spectrum 1010a and the pre-acquired reflection spectrum 1020 coincide with each other at the first wavelength x1. In an example embodiment, the electronic device may shift the measured reflection spectrum 1010a by a difference (=ym1−yr1) between the measured value ym1 at the first wavelength x1 of the reflection spectrum 1010a and the pre-acquired value yr1 at the first wavelength x1 of the reflection spectrum 1020.

The electronic device may scale the shifted reflection spectrum such that values of the measured reflection spectrum 1010a and the pre-acquired reflection spectrum 1020 coincide with each other at the second wavelength x2. In an example embodiment, the electronic device may scale the shifted reflection spectrum by a ratio (=(yr2−yr1)/(ym2−ym1) of a difference (=yr2−yr1) between a pre-acquired value yr2 at the second wavelength x2 and the pre-acquired value yr1 at the first wavelength x1 of the pre-acquired reflection spectrum with respect to a difference (=ym2−ym1) between a measured value ym2 at the second wavelength x2 and the measured value ym1 at the first wavelength x1 of the measured reflection spectrum.

The electronic device may analyze the makeup of the skin based on a comparison between the normalized reflection spectrum 1010b and the pre-acquired reflection spectrum 1020, at a specific wavelength xp. In an example embodiment, the processor 210 may analyze the makeup of the skin based on the difference (=ymp−yrp) between a measured value ymp of the normalized reflection spectrum 1010b and the pre-acquired value yrp of the reflection spectrum 1020 at a specific wavelength xp. In an example embodiment, the processor 210 may analyze the makeup of the skin based on the difference in slopes of the normalized reflection spectrum 1010b and the pre-acquired value of the reflection spectrum 1020 at a specific wavelength xp.

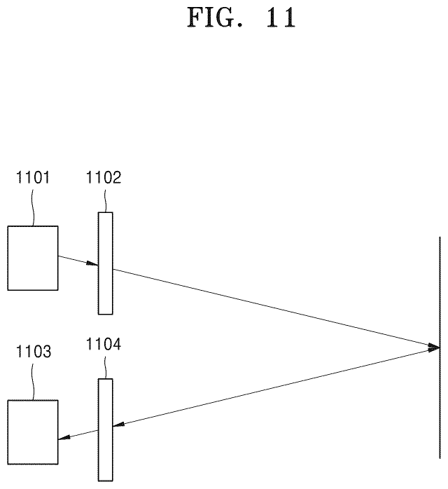

FIG. 11 is a diagram for describing a method of measuring a reflection spectrum using polarizing plates 1102 and 1104 according to an example embodiment.

The electronic device according to an example embodiment may include a light source 1101, a first polarizing plate 1102, a multispectral image sensor 1103, and a second polarizing plate 1104. The first polarizing plate 1102 and the second polarizing plate 1104 may have polarization axes perpendicular to each other.

The light source 1101 may emit electromagnetic waves toward the skin. The electromagnetic waves may pass through the first polarizing plate 1102 to reach the user's skin. Electromagnetic waves reflected from the user's skin may pass through the second polarizing plate 1104. The multispectral image sensor 1103 may measure the reflection spectrum from the user's skin by using the electromagnetic waves passing through the second polarizing plate 1104.

When electromagnetic waves undergo total internal reflection at the user's skin, the reflection spectrum may not include information related to makeup of the user's skin. In this case, an incorrect makeup condition may be derived from the reflection spectrum.

The first and second polarizing plates 1102 and 1104 may be used to block the reflection spectrum undergone the total internal reflection at the user's skin from being measured by the multispectral image sensor 1103. When there is an interaction (e.g., absorption) between the electromagnetic waves and the user's skin, the direction of vibration of the electromagnetic waves may change, but when the electromagnetic waves undergo total internal reflection at the user's skin, the direction of vibration of the electromagnetic waves may not change. The second polarizing plate 1104 may block polarization ingredients of the electromagnetic waves passing through the first polarizing plate 1102. For example, the second polarizing plate 1104 may block ingredients of which the vibration direction of the electromagnetic waves passing through the first polarizing plate 1102 is not changed. Accordingly, when the electromagnetic waves undergo total internal reflection at the skin, they may be blocked by the second polarizing plate 1104.

As the reflection spectrum undergone total internal reflection at the user's skin is blocked from being measured by the first and second polarizing plates 1102 and 1104, incorrect makeup conditions may be prevented from being derived from the reflection spectrum.

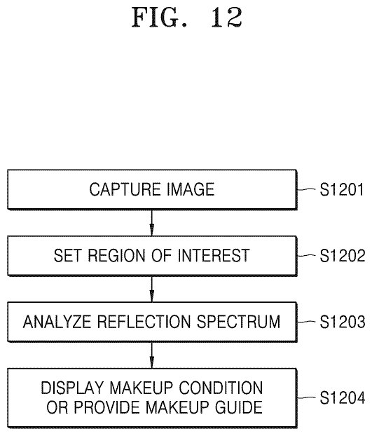

FIG. 12 is a flowchart illustrating a method of analyzing makeup using a multispectral image sensor according to an example embodiment.

In operation S1201, the electronic device may capture an image.

The electronic device may capture an image of a user using a multispectral image sensor or an RGB image sensor. The electronic device may display the captured image.

In operation S1202, the electronic device may set a region of interest.

The electronic device may set a region of interest among the user's skin regions for analyzing makeup. In an example embodiment, the electronic device may automatically set a region of interest. For example, the electronic device may automatically set the user's face, eyes, or forehead as regions of interest in an image. In another example embodiment, the electronic device may set a region of interest from a user input. For example, the electronic device may set a region selected by the user on an image as a region of interest.

In operation S1203, the electronic device may analyze the reflection spectrum.

The electronic device may measure the reflection spectrum of the region of interest through the multispectral image sensor. In the electronic device, a reflection spectrum of the user's skin without makeup may be obtained in advance. The electronic device may analyze a makeup condition of the region of interest based on a comparison between the measured reflection spectrum and the pre-acquired reflection spectrum.

In operation S1204, the electronic device may display a makeup condition or provide a makeup guide.

The electronic device may provide the user with a makeup condition through an output device such as a display panel or a speaker, or may provide a makeup guide so that the user may wear a correct makeup.

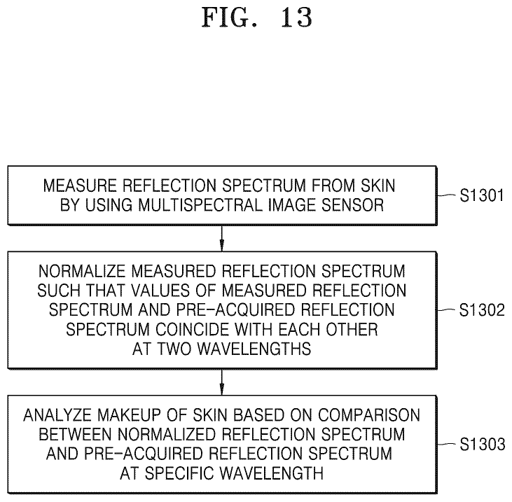

FIG. 13 is a flowchart illustrating a method of analyzing makeup using a multispectral image sensor according to an example embodiment.

In operation S1301, the electronic device may measure the reflection spectrum from the skin using the multispectral image sensor.

Since the multispectral image sensor includes a large number of channels, the multispectral image sensor may measure the reflection spectrum from the skin with relatively high resolution.

In operation S1302, the electronic device may normalize the measured reflection spectrum such that values of the measured reflection spectrum and the pre-acquired reflection spectrum coincide at two wavelengths.

The electronic device may correct the measured reflection spectrum based on the pre-acquired reflection spectrum. The electronic device may shift the measured reflection spectrum so that a value of the measured reflection spectrum coincides with a value of the pre-acquired reflection spectrum, at a specific wavelength. The electronic device may scale the shifted reflection spectrum so that a value of the measured reflection spectrum coincides with a value of the pre-acquired reflection spectrum, at another wavelength.

In operation S1303, the electronic device may analyze the makeup of the skin based on a comparison between the normalized reflection spectrum and the pre-acquired reflection spectrum at a specific wavelength.

The specific wavelength may be included in a wavelength band in which the difference between the reflection spectrum from the makeup skin and the reflection spectrum from the non-makeup skin is more clearly revealed. In an example embodiment, the specific wavelength may be included in a wavelength range of about 570 nm to about 600 nm. The electronic device may analyze the makeup of the skin based on a difference in values or slopes of the normalized reflection spectrum and the pre-acquired reflection spectrum at a specific wavelength.

In addition, example embodiments may also be implemented in the form of a recording medium including instructions executable by a computer, such as a program module executed by a computer. Computer-readable media may be any available media that may be accessed by a computer, and include all of volatile and nonvolatile media, and detachable and non-detachable media. In addition, computer-readable media may include computer storage media and communication media. Computer storage media include all of volatile and nonvolatile, and detachable and non-detachable media implemented by any method or technology for storing information, such as computer-readable instructions, data structures, program modules, or other data.

In addition, computer-readable storage media may be provided in the form of non-transitory storage media. Here, the “non-transitory storage medium” only means that it is a device that is tangible and does not include a signal (e.g., electromagnetic waves), and this term does not distinguish between the case where data is stored semi-permanently in the storage medium and the case where data is stored temporarily. For example, the “non-transitory storage medium” may include a buffer in which data is temporarily stored.

A method according to various example embodiments may be included in a computer program product and provided. Computer program products may be traded between sellers and buyers as products. A computer program product may be distributed in the form of a device-readable storage medium (e.g., compact disc read only memory (CD-ROM), or may be distributed directly or online (e.g., downloaded or uploaded) through an application store or between two user devices (e.g., smartphones). In the case of online distribution, at least part of a computer program product (e.g., a downloadable app) may be temporarily stored or created on a device-readable storage medium, such as a manufacturer's server, an application store's server, or a relay server's memory.

It should be understood that example embodiments described herein should be considered in a descriptive sense only and not for purposes of limitation. Descriptions of features or aspects within each example embodiment should typically be considered as available for other similar features or aspects in other embodiments. While example embodiments have been described with reference to the figures, it will be understood by those of ordinary skill in the art that various changes in form and details may be made therein without departing from the spirit and scope as defined by the following claims and their equivalents.

What is claimed is:

1. A method of analyzing makeup by a multispectral image sensor, the method comprising:
measuring a reflection spectrum of skin by the multispectral image sensor;
normalizing the measured reflection spectrum by matching a value of the measured reflection spectrum and a value of a pre-acquired reflection spectrum at two wavelengths; and
analyzing makeup of the skin based on comparing the normalized reflection spectrum and the pre-acquired reflection spectrum at a specific wavelength.

2. The method of claim 1, wherein the measuring of the reflection spectrum of the skin comprises measuring the reflection spectrum of the skin by the multispectral image sensor that comprises channels respectively corresponding to the two wavelengths and the specific wavelength.

3. The method of claim 1, wherein the specific wavelength is included in a range of 570 nm to 600 nm.

4. The method of claim 1, wherein the specific wavelength is between the two wavelengths.

5. The method of claim 1, wherein the normalizing of the measured reflection spectrum further comprises:
shifting the measured reflection spectrum to match the measured reflection spectrum and the pre-acquired reflection spectrum at one of the two wavelengths; and
scaling the shifted reflection spectrum to match the measured reflection spectrum and the pre-acquired reflection spectrum at the other of the two wavelengths.

6. The method of claim 1, wherein the analyzing of the makeup of the skin further comprises analyzing a condition of the makeup of the skin based on a difference between the normalized reflection spectrum and the pre-acquired reflection spectrum at the specific wavelength.

7. The method of claim 1, wherein the analyzing of the makeup of the skin further comprises analyzing a condition of the makeup of the skin based on a difference in a slope of the normalized reflection spectrum and a slope the pre-acquired reflection spectrum at the specific wavelength.

8. The method of claim 1, wherein the analyzing of the makeup of the skin further comprises:
analyzing a condition of the makeup of the skin; and
providing a makeup guide to a user.

9. The method of claim 1, wherein the measuring of the reflection spectrum of the skin comprises:
emitting electromagnetic waves by a light source through a first polarizing plate to the skin; and
measuring, by the multispectral image sensor, the electromagnetic waves that have been reflected by the skin and have passed through a second polarizing plate that has a polarizing axis perpendicular to a polarizing axis of the first polarizing plate.

10. The method of claim 1, wherein the pre-acquired reflection spectrum is a reflection spectrum of the skin without makeup.

11. An electronic device for analyzing makeup, the electronic device comprising:
a multispectral image sensor configured to measure a reflection spectrum of skin;
a memory configured to store one or more instructions; and
at least one processor configured to execute the one or more instructions stored in the memory,
wherein the at least one processor is, by executing the one or more instructions, configured to:
normalize the measured reflection spectrum to match a value of the measured reflection spectrum and a value of a pre-acquired reflection spectrum at two wavelengths; and
analyze the makeup of the skin based on comparing the normalized reflection spectrum and the pre-acquired reflection spectrum at a specific wavelength.

12. The electronic device of claim 11, wherein the multispectral image sensor comprises channels corresponding to the two wavelengths and the specific wavelength.

13. The electronic device of claim 11, wherein the specific wavelength is included in a range of 570 nm to 600 nm.

14. The electronic device of claim 11, wherein the specific wavelength is between the two wavelengths.

15. The electronic device of claim 11, wherein the at least one processor is, by executing the one or more instructions, configured to:
shift the measured reflection spectrum to match the measured reflection spectrum and the pre-acquired reflection spectrum at one of the two wavelengths; and
scale the shifted reflection spectrum to match the measured reflection spectrum and the pre-acquired reflection spectrum at the other of the two wavelengths.

16. The electronic device of claim 11, wherein the at least one processor is, by executing the one or more instructions, further configured to:
analyze a condition of the makeup of the skin based on a difference between a value of the normalized reflection spectrum and a value of the pre-acquired reflection spectrum at the specific wavelength.

17. The electronic device of claim 11, wherein the at least one processor is, by executing the one or more instructions, further configured to:
analyze a condition of the makeup of the skin based on a difference in a value of a slope of the normalized reflection spectrum and a value of a slope of the pre-acquired reflection spectrum at the specific wavelength.

18. The electronic device of claim 11, wherein the at least one processor is, by executing the one or more instructions, further configured to:
analyze a condition of the makeup of the skin; and
provide a makeup guide to a user.

19. The electronic device of claim 11, further comprising:
a light source;
a first polarizing plate configured to transmit electromagnetic waves emitted from the light source; and
a second polarizing plate configured to transmit the electromagnetic waves reflected from a skin,
wherein the multispectral image sensor is further configured to measure the electromagnetic waves transmitted through the second polarizing plate, and
wherein a polarizing axis of the first polarizing plate is perpendicular to a polarizing axis of the second polarizing plate.

20. A non-transitory computer-readable recording medium having recorded thereon a program for executing a method on a computer, the method comprising:
measuring a reflection spectrum of skin by a multispectral image sensor;
normalizing the measured reflection spectrum by matching a value of the measured reflection spectrum and a value of a pre-acquired reflection spectrum at two wavelengths; and
analyzing makeup of the skin based on a comparing the normalized reflection spectrum and the pre-acquired reflection spectrum at a specific wavelength.

21. An electronic device for analyzing makeup, the electronic device comprising:
a light source configure to emit electromagnetic waves to skin;
a multispectral image sensor configured to measure a reflection spectrum of the skin based on the electromagnetic waves reflected from the skin; and
at least one processor configured to:
normalize the measured reflection spectrum to match a value of the measured reflection spectrum and a value of a pre-acquired reflection spectrum at two wavelengths; and
analyze makeup of the skin based on comparing the normalized reflection spectrum and the pre-acquired reflection spectrum at a specific wavelength,
wherein the multispectral image sensor comprises channels corresponding to the two wavelengths and the specific wavelength.
